(19) United States
(12) Patent Application Publication
(10) Pub. No.: US 2022/0388604 A1
(43) Pub. Date: Dec. 8, 2022

(54) REAR DERAILLEUR WITH WIRELESS FLOATING DRIVE

(71) Applicant: ZUMA INNOVATION S.L, Galdakao-Bizkaia (ES)

(72) Inventors: Mikel ZUBIETA ANDUEZA, Galdakao - Bizkaia (ES); Jon MADARIAGA LANDAJO, Galdakao - Bizkaia (ES)

(21) Appl. No.: 17/776,274

(22) PCT Filed: Nov. 12, 2020
(86) PCT No.: PCT/EP2020/081934

§ 371 Date: May 12, 2022

(30) Foreign Application Priority Data
Nov. 21, 2019 (ES) U201931918

(51) Int. Cl. B62M 9/1242; B62M 9/122; B62M 9/125

(52) U.S. Cl. CPC B62M 9/1242; B62M 9/122; B62M 9/125

(57) ABSTRACT

A rear derailleur for bicycles includes an articulated quadrilateral mechanism composed of a base component and a movable component, connected to each other by first and second connector components articulated with respect to components, a chain tensioner connected to the movable component, and a floating linear actuation unit composed of a base body, articulated with respect to one of the components of the articulated quadrilateral mechanism and a movable body for deforming the articulated quadrilateral mechanism, and causing a displacement of the chain tensioner with a main component in direction of the wheel axle A. The rear derailleur further includes a power-supply arranged on the floating linear actuation unit and a wireless unit including a wireless receiver, the wireless unit being arranged on the floating linear actuation unit.

### TECHNICAL FIELD

The present disclosure belongs to the field of electric rear derailleurs for bicycles.

### BACKGROUND

With the exception of a few cases such as EP0558425B1 and U.S. Pat. No. 9,334,017B2, the rear derailleurs on the market typically use a deformable parallelogram kinematic mechanism (composed of a base component, a movable component and two connecting components) to move the chain tensioner (mounted on the movable component) in direction of the wheel axle to align it with different cassette sprockets and thus control the gear ratio of the bicycle. Control of the position of the derailleur is done by varying the relative position of two of the four components or sides of the parallelogram. The mechanical rear derailleurs generally have a cable arranged between two of the sides of the parallelogram which, when tensioned, deforms the parallelogram to move the chain tensioner in one direction, and a traction spring arranged between two of the sides of the parallelogram that deforms the parallelogram to move the chain tensioner in the opposite direction when the cable is relaxed. In some embodiments such as U.S. Pat. No. 4,838,837A, EP3339159A1 a torsion spring is used which impinges on two adjacent sides of the articulated quadrilateral.

In the electric rear derailleur described in U.S. Pat. No. 5,470,277A, the cable-based linear drive of the most common mechanical derailleurs is replaced by a floating linear electric drive placed between the same points. The floating linear electric drive can deform the articulated quadrilateral in both directions, even so, in certain embodiments such as EP1568596B1 a spring is maintained that tends to deform the articulated quadrilateral in one of the directions in order to eliminate the backlash of the electric drive and improve its operation against vibrations. But the incorporation of this spring requires that the drive can perform greater forces, especially in gear changes in which the spring has larger preload.

On electronic rear derailleurs, adding a position sensor to the electric drive allows for more precise positioning of the derailleur by closing the control loop. Also, a battery is required for power input. In the solution described in U.S. Pat. No. 5,470,277A both the battery and the position sensor are arranged outside the rear derailleur (usually in the bicycle frame), while in solutions U.S. Pat. No. 5,480,356A and EP1103456B1 the position sensor is integrated into the rear derailleur (generally in the motor itself). In all these solutions, the shift order requested by the user is transmitted to the rear derailleur through a cable that also incorporates the drive power signal.

In the electric rear derailleur described in U.S. Pat. No. 6,162,140A, a rotary drive is used that affects two adjacent sides of the articulated quadrilateral to deform it and move the chain tensioner in both directions, and has a spring that preloads the system in one direction to improve its operation against vibrations. The position sensor is built into the rear derailleur, but power and shift commands are communicated with a wire from outside the rear derailleur.

In order to facilitate the mounting of the derailleur, in patent U.S. Pat. No. 9,394,030B2 the required wiring between the power-supply, controls and electric rear derailleur is eliminated. The solution is based on a rotary drive that affects two adjacent sides of the articulated quadrilateral with a spring that preloads the quadrilateral, in which the sensor is integrated in the rear derailleur, but also the battery that powers the system, being the shift commands of the user transmitted wirelessly. Specifically, the battery, which is removable for recharging, can be located both in the base component and in the movable component. The electric rear derailleur in EP3363726A1 is similar to the one in U.S. Pat. No. 9,394,030B2 with the difference that the removable battery is disposed on one of the connecting components of the articulated quadrilateral. The electric rear derailleur in U.S. Pat. No. 10,370,060B2 is also commanded wirelessly even if the battery is not integrated into the rear derailleur, but just mounted close to it.

### SUMMARY

To provide a solution to the shortcomings of the state of the art, the present disclosure proposes an electric rear derailleur for bicycles that comprises:

an articulated quadrilateral mechanism composed of a base component configured to be mounted to the bicycle frame and a movable component, connected to each other by a first connector component and a second connector component articulated with respect to the base component and the movable component,

a chain tensioner connected to the moving component, and

a floating linear actuation unit composed of a base body, articulated with respect to one of the components of the articulated quadrilateral mechanism and a movable body articulated with respect to another of the components of the articulated quadrilateral mechanism, suitable for deforming the articulated quadrilateral mechanism, so that a displacement of the movable component with respect to the base component is defined, and consequently a displacement of the chain tensioner with a main component in the direction of the wheel axis,

in which the electric rear derailleur further comprises:

a power-source arranged on the floating linear actuation unit; and

a wireless unit including a wireless receiver configured to receive a wireless signal, the wireless unit being arranged on the floating linear actuation unit.

Known embodiments of electric rear derailleur with articulated quadrilateral mechanism and floating linear actuation, such as EP1103456B1, require to be wired to the battery integrated in the frame and to the controls located on the handlebar. To facilitate assembly and maintenance tasks, it is proposed for the first time that the battery be integrated into the floating linear actuation unit itself and that the change orders are transmitted wirelessly by a wireless unit.

In this way, all the electronics are integrated into the floating linear actuation unit, which presents manufacturing and maintenance advantages over other wireless rear derailleur solutions with articulated quadrilateral mechanism such as U.S. Pat. No. 9,394,030B2 and EP3363726A1 in which the electronic part is distributed, and completely integrated, among the different components; base component, moving component and connecting components. This integration implies that in the event of a breakdown in the electrical part, it is necessary to replace the entire rear derailleur, while in the proposed solution, only the floating linear actuation unit would be replaced, reducing assembly times (it does not require disassembling the chain and re-adjusting the derailleur position), storage space, shipping costs (smaller size) and manufacturing costs (only the part that has failed is replaced) and can offer better customer service. Additionally, the separation of the electrical part—floating linear actuation unit—from the mechanical part—articulated quadrilateral mechanism and chain tensioner—can specialize the manufacturing and assembly lines of both parts, reducing manufacturing costs.

In some embodiments the electric rear derailleur comprises at least one position estimator arranged on the floating linear actuation unit. It is advantageous to also integrate the position estimator in the floating linear actuation unit in order to locate all the electrical parts in the same mounting unit.

In some embodiments a position estimator estimates the relative linear position between the floating linear actuation unit and one of the components of the articulated quadrilateral mechanism.

The floating linear actuator unit, and all the elements disposed therein, describe during operation of the rear derailleur a unique movement different to any member of the quadrilateral mechanism, so that the relative position between the floating linear actuator unit and any of the members of the quadrilateral mechanism fully defines the position of the rear derailleur during operation.

The position estimator could be composed of a non-contact proximity sensor (capacitive, inductive, . . . ) that measures the distance with respect to the second connector component as shown in FIGS. 7A and 7B, or it could be a contact sensor (potentiometer, LVDT, . . . ) that rests or articulates on the second connector component or other member of the articulated quadrilateral mechanism.

In some embodiments, the base body of the floating linear actuation unit comprises a motor with a gearbox that drives a screw, and where the movable body of the floating linear actuation unit comprises a nut.

A preferred configuration to obtain a floating linear actuation unit is to locate a motor with a gearbox and a screw in the base body so that its rotation axially displaces the nut located in the moving part. For the correct operation of the system, the base body and the movable body must have restricted rotation with respect to the axis of the screw in their assembly with respect to the articulated quadrilateral mechanism.

In some embodiments, a position estimator estimates the angular position of the motor, gearbox, or screw. In configurations in which a rotary motor is used it may be advantageous to measure its position using a position estimator (optical encoder magnetic encoder, . . . ) integrated into the motor itself for more direct control dynamics. Alternatively, the rotary position estimator could also be integrated in the gearbox or screw connected to the motor.

In some embodiments, the base body comprises a housing that contains the motor, the gearbox, the power-supply, the wireless unit and at least one position estimator. Preferably, all the electrical elements, located in the floating linear actuation unit, will be contained in a hermetically sealed casing.

In some embodiments the electric rear derailleur comprises:

a preload-screw flexibly connected to the screw so that it can contact the flanks of the nut where the spindle does not contact, or

a preload-nut flexibly connected to the nut so that it can contact on the flanks of the screw where the nut does not contact.

Known electronic rear derailleur solutions—such as EP1568596B1, U.S. Pat. Nos. 6,162,140A, or 9,394,030B2—have a spring arranged in the articulated quadrilateral mechanism to bring the moving component to one of its extreme positions relative to the base component. But the main function of this spring is to eliminate the backlash of the electric actuation mechanism and to guarantee a stable position of the derailleur in its operation. This configuration has the disadvantage that the preload exerted on the actuation mechanism is variable with the position of the derailleur, so in order to have sufficient preload in all positions, the preload can be too high in some of the positions and require too much energy from the actuation mechanism.

In the proposed solution, using a preload in the screw-nut mechanism, it is possible to eliminate the backlash of the actuation mechanism, and since the preload is independent of the position of the derailleur, the energy demanded from the actuation mechanism can be reduced.

In some embodiments the attraction or repulsion force, in the axial direction of the screw, between the screw and the preload-screw, or between the nut and the preload-nut is exerted magnetically.

While in other embodiments the screw and the preload-screw, or the nut and the preload-nut, form a single body whose flexibility favors the attractive or repulsive force between the screw and the preload-screw, or the nut and the preload-nut.

In some embodiments the articulated quadrilateral mechanism is an articulated parallelogram mechanism. The articulated parallelogram mechanism is an articulated quadrilateral mechanism in which the opposite sides of the quadrilateral have the same length, and has the particularity that the sides do not undergo relative rotation during displacement. Thus, the articulated parallelogram mechanism is appropriate when it is intended that the movable component does not undergo rotations during its displacement relative to the base component, so that the chain tensioner is kept aligned with respect to the bicycle sprockets.

In some embodiments, the base body and the first connector component or the second connector component are articulated relative to the base component along the same axis, and the movable body and the connector component are articulated relative to the movable component along the same axis.

In a preferred configuration, the floating linear actuation unit shares articulation points with the articulated quadrilateral mechanism (it is arranged on the diagonal of the quadrilateral) to obtain a simpler, more compact and robust solution.

In some embodiments the floating linear actuation unit is arranged above the moving component. Thus, both the floating linear actuation and the articulated quadrilateral are in a more horizontal situation and less sensitive to ground vibrations.

In some embodiments the floating linear actuation unit is disposed below the base component.

In some embodiments, the first connector component and/or the second connector component have a single contact surface relative to the base component in a direction perpendicular to its movement.

With this arrangement the size of the base component is reduced, and space is gained below of the floating linear actuation unit.

In some embodiments the power-supply is removably connected to the floating linear actuation unit. Thus, the battery is easily removable from the derailleur to be able to charge it in a specific charging device that can be connected to the electrical grid.

In some embodiments the power-supply is arranged behind the floating linear actuation unit for better access to the battery. While in other embodiments the power-supply is arranged below the floating linear actuation unit for more integrated aesthetics and greater protection against impacts.

In some embodiments the floating linear actuation unit comprises at least one manual switch. These can be push buttons, sliders, or rotary potentiometers with two or more positions and would be used to turn the device on and off, to initiate pairing with other streaming devices, or for other setup or tuning tasks.

In some embodiments the floating linear actuation unit comprises at least one light emitter. They can be fixed color LEDs or several colors with different sequences to transmit different messages; the system is on, a shift order has been received, the configuration has been carried out correctly, the configuration has not been carried out correctly, malfunction, low battery, . . .

The concepts described can also be applied to other equivalent configurations and different sizes.

### BRIEF DESCRIPTION OF THE DRAWINGS

To complement the description and in order to help a better understanding of the characteristics of the disclosure, according to an example of a practical embodiment thereof, a set of figures is attached as an integral part of the description, in which with character Illustrative and not limiting, the following has been represented:

FIG. 1 shows a general view of the electric rear derailleur mounted on the frame of a bicycle.

FIG. 2 is a detailed view of FIG. 1.

FIG. 3 shows an exploded view of the main assembly elements of the electric rear derailleur: the articulated quadrilateral mechanism, the chain tensioner and the floating linear actuation unit.

FIG. 4 shows the articulated quadrilateral mechanism in greater detail.

FIG. 5 shows the floating linear actuation unit in greater detail.

FIGS. 6A and 6B show a screw-nut mechanism configuration with no backlash.

FIGS. 7A and 7B show the extreme positions of the electric rear derailleur that its operating range.

FIGS. 8A and 8B show an electric rear derailleur solution with the power-supply arranged behind the floating linear actuating unit.

FIGS. 9A and 9B show an electric rear derailleur solution with the power-supply disposed below the floating linear actuation unit.

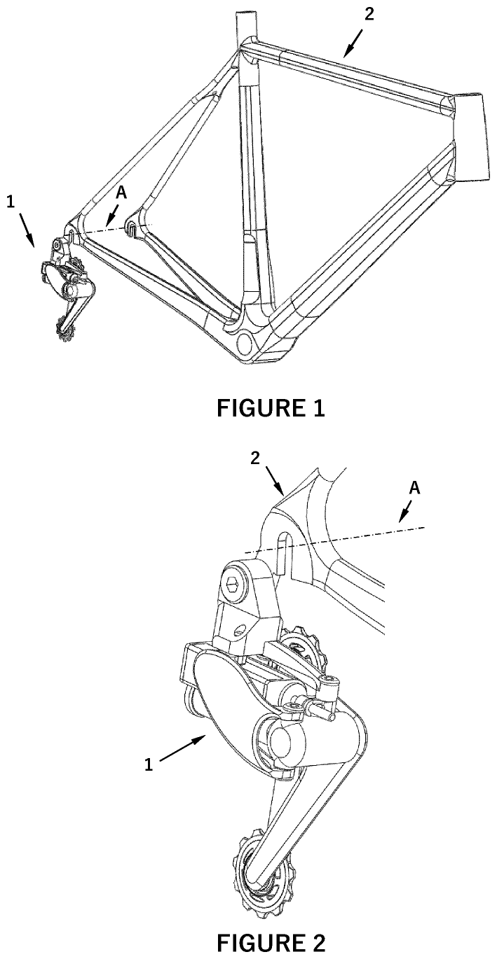

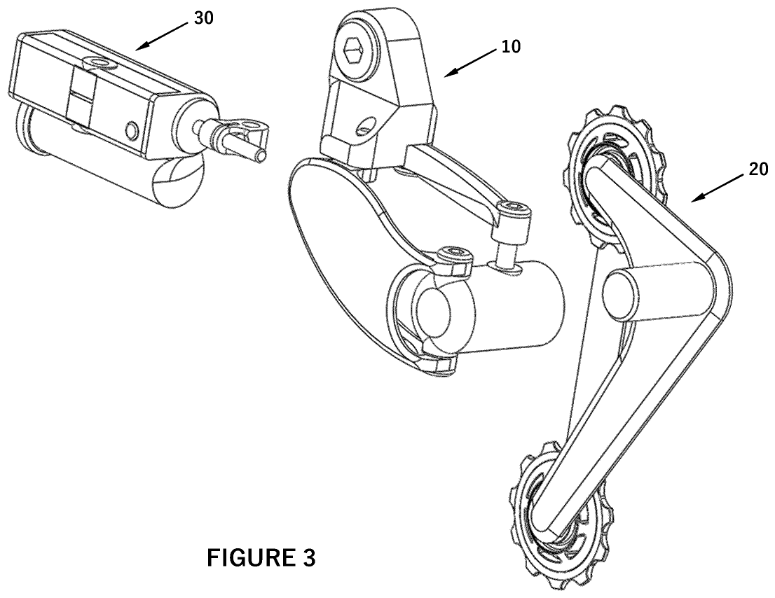

### DETAILED DESCRIPTION OF THE DRAWINGS

As it can be seen in the figures, the disclosure refers to an electric rear derailleur 1 for bicycles comprising:

an articulated quadrilateral mechanism 10 composed of a base component 11 configured to be mounted to the bicycle frame 2 and a movable component 12, connected to each other by a first connector component 13 and a second connector component 14 articulated with respect to the base component 11 and to the moving component 12,

a chain tensioner 20 connected to moving component 12, and

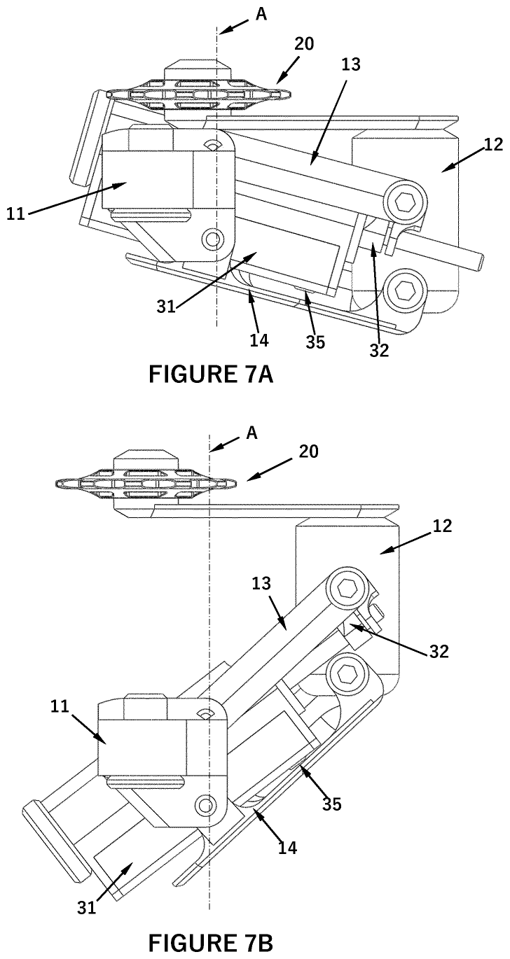

a floating linear actuation unit 30 composed of a base body 31, articulated with respect to one of the components of the articulated quadrilateral mechanism 11, 12, 13, 14 and a movable body 32 articulated with respect to another of the components of the articulated quadrilateral mechanism 11, 12, 13, 14, suitable for deforming the articulated quadrilateral mechanism 10, such that a displacement of the movable component 12 with respect to the base component 11 is defined, and consequently a displacement of the chain tensioner 20 with a main component in direction of the wheel axle A, as it can be seen in FIGS. 7A and 7B which show the limit positions of the derailleur corresponding respectively to engagement of the smallest sprocket and largest sprocket of the bicycle.

As it can be seen in these figures, the articulated quadrilateral mechanism 10 is an articulated parallelogram mechanism that defines a translation of the chain tensioner 20 without its rotation.

It is also observed that the base body 31 is articulated with respect to the base component 11 coaxially as the second connector component 14 is articulated with respect to the base component 11, and the movable body 32 is articulated with respect to the movable component 12 coaxially as the other connector component 13 is articulated with respect to the movable component 12. That is, the floating linear actuation unit 30 is arranged in the diagonal of the articulated quadrilateral 10 sharing two of its articulations to obtain a more compact, light and cheap assembly.

According to the disclosure the electric rear derailleur additionally comprises a power-supply 33 arranged on the floating linear actuation unit 30.

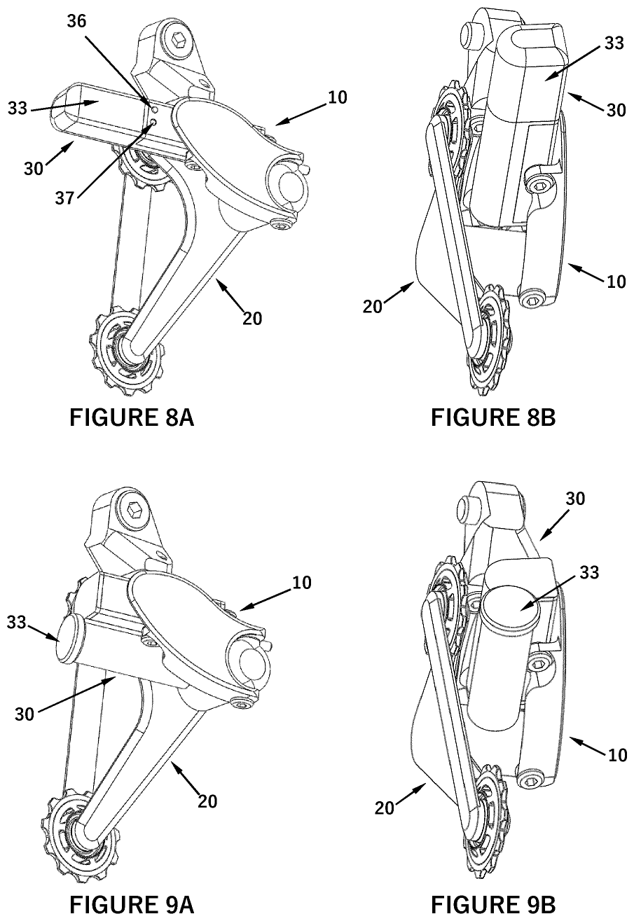

In a first embodiment, as it can be seen in FIGS. 8A and 8B, the power-supply 33 is arranged behind the floating linear actuation unit 30, removably connected thereto. Thus, the battery is easily accessible when removing it for its recharge, but it has the disadvantage of being exposed to impacts.

In this embodiment it is observed that the floating linear actuation unit 30 is arranged above the movable component 12, whereby the plane in which the articulated quadrilateral 10 is deformed is more parallel to the ground than in other solutions of the state of the art such as U.S. Pat. No. 5,470,277A. This configuration entails a more stable position of the derailleur because the parallelogram is less sensitive to vibrations coming from the terrain that have a component perpendicular to the ground.

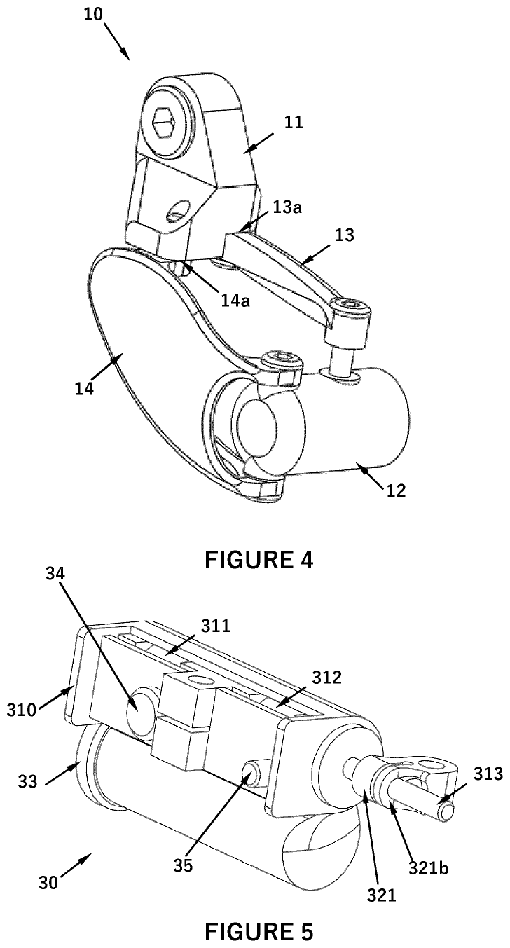

In this embodiment it is also observed that the floating linear actuation unit 30 is arranged below the base component 11, and that the first connector component 13 and the second connector component 14 have a single contact surface 13a, 14a with respect to the base component 11 in a direction perpendicular to its movement as shown in FIG. 4. Thus, in FIGS. 8A and 8B it can be seen that a large space is formed below the floating linear actuation unit 30.

Thus, in a preferred embodiment, as shown in FIGS. 9A and 9B, in which the same mechanical configuration is used for the articulated quadrilateral 10, the space observed in the embodiment of FIGS. 8A and 8B is better used, by arranging the power-supply 33 below the floating linear actuator unit 30. In this way a more compact and aesthetic solution is obtained in which the battery is more protected from shocks.

An advantage of the disclosed embodiments is that the floating linear actuation unit 30 can be easily removed from the electric rear derailleur 1, leaving the articulated quadrilateral 10 and the chain tensioner 20 structurally operational. That is, the floating linear actuation unit 30 does not fulfill mechanical structural functions.

In the embodiments described in the figures, the floating linear actuation unit 30 comprises all electrical elements of the electric rear derailleur 1, that is, comprises in addition to the power-supply 33:

a motor 311 with a gearbox 312 that drives a screw 313, and a nut 321

a position estimator that estimates the angular position of motor 311, gearbox 312 or screw 313

a second position estimator 35 that estimates the relative linear position between the floating linear actuation unit 30 and one of the articulated quadrilateral mechanism components 11, 12, 13, 14

a wireless unit 34 including a wireless receiver configured to receive a wireless signal

a housing 310 containing motor 311, gearbox 312, power-supply 33, wireless unit 34, and at least one position estimator 35, and

additionally, it may comprise at least one manual switch 36, and at least one light emitter 37 as shown in FIG. 8A

This configuration in which the electrical part (floating linear actuation unit 30) is differentiated from the mechanical part (articulated quadrilateral 10 and chain tensioner 20) simplifies the manufacturing of the electric rear derailleur 1, because no mechanical properties are required for the electrical part, nor electrical properties (or sealing) are required for the mechanical part. This configuration also facilitates maintenance work, since in the event of an electrical breakdown, the electrical part can be easily disassembled (without disassembling the mechanical part and losing alignment with the rest of the mechanical components of the bicycle) and shipping it independently for repairing. And in the case of being necessary to replace it with a new unit, it is sufficient to replace the floating linear actuating unit 30 and not all the electric rear derailleur 1, which implies costs.

In the embodiments described in the figures, the electric rear derailleur 1 comprises:

a preload-screw 313b flexibly connected to screw 313 so that it contacts flanks of nut 321 where screw 313 does not contact, or

a preload-nut 321b flexibly connected to nut 321 so that it contacts at the flanks of screw 313 where nut 321 does not contact.

In this way, it is possible to eliminate the backlash of the drive without having to resort to a spring as it is done in the electric rear derailleurs known from the state of the art, and thus avoiding oversizing of the drive to cope with the high forces generated by the spring in certain positions.

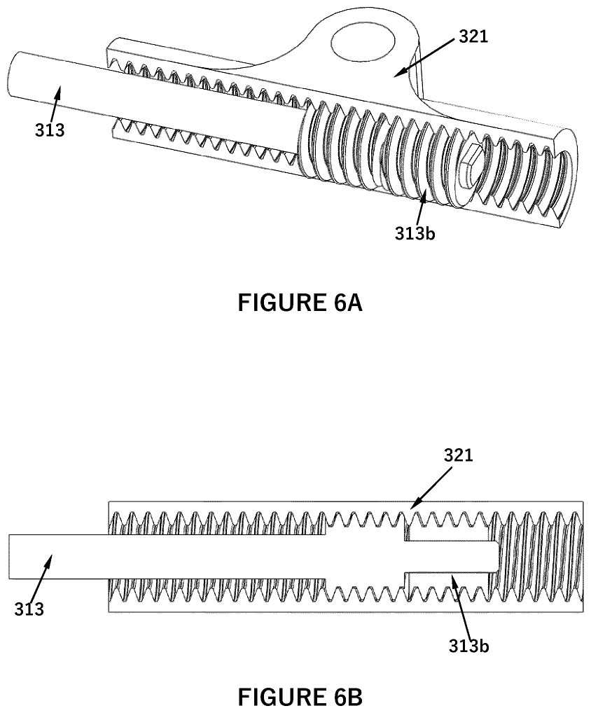

More specifically, in the embodiment described in FIGS. 6A and 6B, the attraction, in the axial direction of the spindle, between the screw 313 and the preload-screw 313b is carried out magnetically. The screw 313 is made of a ferric material and the preload-screw 313b is made of a magnetized ferric material, so that both are attracted generating a preload (constant for any position of the electric rear derailleur 1) that eliminates any backlash in the actuation.

In the embodiment described in FIG. 5, the nut 313 and the preload-nut 313b form

a single body whose flexibility promotes the attractive force between the nut 313 and the preload-nut 313b, obtaining similar advantages to the previous embodiment.

In this text, the word “comprise” and its variants (such as “comprising”, etc.) should not be interpreted in an exclusive way, that is, they do not exclude the possibility that what is described includes other elements, steps, etc.

On the other hand, the disclosure is not limited to the specific embodiments that have been described but also encompasses, for example, the variants that can be carried out by the average person skilled in the art (for example, regarding the choice of materials, dimensions, components, configuration, etc.), within the general scope of the disclosure as defined in the claims.

1. A rear derailleur for bicycles comprising:
an articulated quadrilateral mechanism composed of a base component configured to be mounted to the bicycle frame and a movable component, connected to each other by a first connector component and a second connector component articulated with respect to the base component and the movable component;
a chain tensioner connected to the movable component, and
a floating linear actuation unit composed of a base body, articulated with respect to one of the components of the articulated quadrilateral mechanism and a movable body articulated with respect to another of the components of the articulated quadrilateral mechanism, for deforming the articulated quadrilateral mechanism, and for causing a displacement of the movable component with respect to the base component, and consequently a displacement of the chain tensioner with a main component in direction of the wheel axle;
wherein the rear derailleur further comprises:
a power-supply arranged on the floating linear actuation unit; and
a wireless unit including a wireless receiver, the wireless unit being arranged on the floating linear actuation unit.

2. The rear derailleur according to claim 1, further comprising a position estimator arranged on the floating linear actuation unit.

3. The rear derailleur according to claim 2, wherein the position estimator is configured to estimate the relative linear position between the floating linear actuation unit and one of the components of the articulated quadrilateral mechanism.

4. The rear derailleur according to claim 4, wherein the base body of the floating linear actuation unit comprises a motor with a gearbox that drives a screw, and wherein the movable body of the floating linear actuation unit comprises a nut complementary to the screw.

5. The rear derailleur according to claim 4, wherein the position estimator is configured to estimate the angular position of the motor, gearbox, or screw.

6. The rear derailleur according to claim 4, wherein the base body comprises a housing containing the motor, gearbox, power-supply, wireless unit, and position estimator.

7. The rear derailleur according to claim 4, comprising:
a preload-screw flexibly connected to the screw in contact with the flanks of the nut that do not contact the screw, or
a preload-nut flexibly connected to the nut that contacts the flanks of the screw that do not contact the nut.

8. (canceled)

9. (canceled)

10. (canceled)

11. The rear derailleur according to claim 1, wherein the base body and the first connector component or the second connector component are articulated with respect to the base component along the same axis, and the movable body and the connector component are articulated with respect to the movable component along the same axis.

12. (canceled)

13. (canceled)

14. The rear derailleur according to claim 1, wherein the power-supply is arranged behind the floating linear actuation unit or wherein the power-supply is arranged below the floating linear actuation unit.

15. The rear derailleur according to claim 1, wherein the power-supply is removably connected to the movable component and/or wherein the floating linear actuation unit comprises at least one manual switch and/or wherein the floating linear actuation unit comprises at least one light emitter.
